(19) United States
(12) Patent Application Publication
(10) Pub. No.: US 2017/0001670 A1
(43) Pub. Date: Jan. 5, 2017

(54) METHOD FOR THE PRODUCTION OF AN EXTERIOR TRIM PANEL FOR A MOVABLE BODY PART AND A CORRESPONDING EXTERIOR TRIM PANEL WITH REINFORCEMENT BY BACK INJECTING FIBRE-REINFORCED MATERIAL

(71) Applicant: ThyssenKrupp Steel Europe AG, Duisburg (DE)

(72) Inventors: Axel Grüneklee, Duisburg (DE); Markus Zörnack, Michigan, MI (US); Andreas Keutz, Düsseldorf (DE); Jens Winiarz, Königswinter (DE)

(73) Assignee: ThyssenKrupp Steel Europe AG, Duisburg (DE)

(21) Appl. No.: 15/039,786

(22) PCT Filed: Nov. 21, 2014
(86) PCT No.: PCT/EP2014/003112

§ 371 Date: May 26, 2016

(30) Foreign Application Priority Data
Nov. 29, 2013 (DE) 10 2013 113 230.8

(51) Int. Cl. B62D 29/00; B32B 15/04; B62D 25/10; B29C 45/14

(52) U.S. Cl. CPC B62D 29/004; B29C 45/14811; B32B 15/04; B62D 25/10; B29D 99/001

(57) ABSTRACT

A method for producing a large outer paneling part for a movable body part of a motor vehicle such as a door, a front hood, or a tailgate may involve using a forming die to form a large metallic panel part into formed panel part having a three-dimensional shape. A reinforcement made of plastic may be applied to at least a portion of an inside of the formed panel part by back injection molding. In some cases, the metallic panel has a sheet metal thickness of less than 0.6 mm, and in some cases less than 0.5 mm. The formed panel part provided with the at least one plastic reinforcement may be connected to an inner structure produced from metal sheet and/or plastic by folding and/or adhesive bonding the plastic reinforcement.

The invention relates to a method for producing a large outer paneling part for a movable body part of a motor vehicle, in particular for a door, front hood or tailgate of a passenger vehicle, in which at least one large metallic panel part forming the outer paneling part is formed by means of a forming die into a three-dimensional shape, wherein a reinforcement made of plastic is at least partially applied to the inside of the formed panel part by back injection molding. Furthermore, the invention relates to an outer paneling part for a movable large body part of a motor vehicle, in particular for a door, front hood or tailgate of a passenger vehicle, formed from a large metallic panel part in accordance with the preamble of claim 9.

The automobile industry is increasingly focused on lightweight construction. In particular, the large outer skin components made of steel provide a considerable potential for a reduction in weight in this regard by means of a reduction in the sheet metal thickness. The conventional outer skin components in the regions of roof, engine hood, tailgate and door currently have a sheet metal thickness within the range of 0.6 mm to 0.8 mm. If steel sheet with a sheet metal thickness of below 0.6 mm is used for the outer skin of said body parts, the outer skin loses a considerable amount of rigidity and the “clicker frog effect” occurs since there is no longer any buckling resistance in some regions.

DE 10 2010 014 541 A1 discloses an outer paneling part for a body of a passenger vehicle, which has at least one large panel part which forms the outer paneling and on the inside of which is arranged a substructure which is formed by a plastics structure arranged at least partially of the panel part. Said outer paneling part is in particular a wing, a side wall or a front hood. The plastics structure which is arranged on the inside of the outer paneling part, and can have plastics ribs crossing one another, is provided in particular in order to reinforce the large panel part in regions to be correspondingly stiffened. Furthermore, in the case of the known outer paneling part, the plastics structure is intended to serve to replace a sheet metal substructure which, in order to reduce the weight of large panel parts, such as front hoods, is joined to the outer paneling part via a welded or crimped connection. DE 10 2010 014 541 A1 proposes injection molding the plastics structure in a forming die onto the panel part formed there. For this purpose, the forming die is provided with, for example, slider parts which, after the final drawing stage of the panel part, are moved in such a manner that the plastics structure can be subsequently produced in one and the same die by injection molding.

Taking this as the starting point, the present invention was based on the object of specifying a further method for producing a large outer paneling part for a movable body part of a motor vehicle, in particular for a door, front hood or tailgate of a passenger vehicle, with which such an outer paneling part can be produced cost-effectively with high quality as a relatively light and nevertheless sufficiently bending- and buckling-resistant outer paneling part. Furthermore, the intention is to provide a corresponding outer paneling part.

This object is achieved according to the invention by a method with the features of patent claim 1 and by an outer paneling part with the features of patent claim 9. Advantageous embodiments of the invention are specified in the dependent claims.

In order to produce a large, high-quality outer paneling part for a movable body part, in particular for a door, front hood or tailgate of a passenger vehicle, cost-effectively, which, while being relatively light, is sufficiently resistant to bending and in particular has sufficient buckling resistance, according to the invention at least one large metallic panel part forming the outer paneling part is formed by means of a forming die into a three-dimensional shape, and a reinforcement made of plastic is subsequently at least partially applied to the inside of the formed panel part by back injection molding, wherein a panel part with a sheet metal thickness of less than 0.60 mm, preferably less than 0.50 mm, in particular less than 0.45 mm, is used as the panel part. The formed panel part provided with the reinforcement is then connected by folding and/or adhesive bonding to an inner structure which is produced from metal sheet and/or plastic.

In particular the inner structure which is produced from metal sheet and/or plastic imparts a sufficiently high bending resistance to the outer paneling part, which is formed from a large panel part, while the plastic which is sprayed onto the inside of the panel part ensures the required buckling resistance of the panel part having a sheet metal thickness of 0.15 mm to less than 0.6 mm.

In addition, the plastic sprayed onto the inside of the panel part has a positive effect on the acoustic properties of the outer paneling part. Furthermore, by means of the inside plastics coating of the thin panel part, the behavior of said panel part is positively influenced in the event of dynamic impact stressing, for example in the event of an impact of a pedestrian against an engine hood designed according to the invention.

An advantageous embodiment of the method according to the invention consists in that the formed panel part is back injection molded outside the forming die with plastic for producing the at least one reinforcement, wherein the panel part is accommodated for this purpose in a manner secured in a holder, for example in a supporting device. The method according to the invention therefore does not require any complicated changing or reconstruction of forming dies for forming and back injection molding the formed panel part. The mechanical stressing of such holders is so low that they are designed in a simple manner and in particular can be composed of nonmetallic materials. One or more such holders can preferably be or have been arranged next to the molding press.

A relatively high reduction in weight of a large outer paneling part with at the same time sufficient buckling resistance can be achieved in particular if, according to a further embodiment of the method according to the invention, fiber-reinforced plastic is used for producing the at least one reinforcement of the panel part. For this purpose, in particular glass fibers or carbon fibers can be added to the plastic, preferably during the back injection molding.

The plastic sprayed onto the inside of the formed panel part in order to reinforce same may be, but does not absolutely have to be, applied over the full area of the inside of the panel part. The plastic is preferably applied merely in regions, in particular to those points of the formed panel part which are critical in terms of buckling. For this purpose, the plastic for producing the at least one reinforcement can be applied in particular locally in one layer. In a further preferred refinement of the method according to the invention, the plastic for producing the at least one reinforcement is applied locally in multiple layers. The application of a plurality of plastic layers is advantageous for reinforcing points which are particularly critical in terms of buckling. Said layers can be formed here from an identical plastic, for example in order locally to increase the thickness of the plastics reinforcement; however, according to a further embodiment of the method according to the invention, they may also be formed from different plastics or from plastics with and without reinforcing fibers.

In order to reinforce the large, relatively thin panel part, use is preferably made of one or various plastics which are suitable for a subsequent cathodic dip coating (CDC) of the panel part. The plastic used according to the invention may be in particular a thermoplastic, preferably on the basis of polyamide, polyethylene or mixtures thereof.

With regard to cost-effective and high-quality coating of outer paneling parts of the type mentioned, in a further preferred embodiment of the method according to the invention, plastic which has a permanent temperature stability of at least 120° C., preferably at least 150° C., particularly preferably at least 180° C., is used for producing the at least one reinforcement.

A further embodiment of the method according to the invention is characterized in that the reinforcement produced from plastic is designed specifically in such a manner that it replaces at least one metallic component, which serves as a reinforcement, of the body part. In other words, the effect achieved by specific local reinforcement of the relatively thin sheet metal of the outer paneling part is that one or more metallic components, otherwise serving as a reinforcement, of the outer paneling part can be saved, which, in turn, is of benefit for the reduction in weight and has a positive effect on the acoustic properties of the component. For example, in the case of an outside door panel, by means of a specific plastics reinforcement in the region of the door windowsills, it is envisaged to save on a metallic door windowsill reinforcement which is otherwise customary here.

The above-mentioned advantages of the invention apply in particular to the outer paneling part according to the invention as claimed in one of claims 9 to 14.

The invention is explained in more detail below with reference to a drawing illustrating a plurality of exemplary embodiments. In the drawing, in each case schematically:

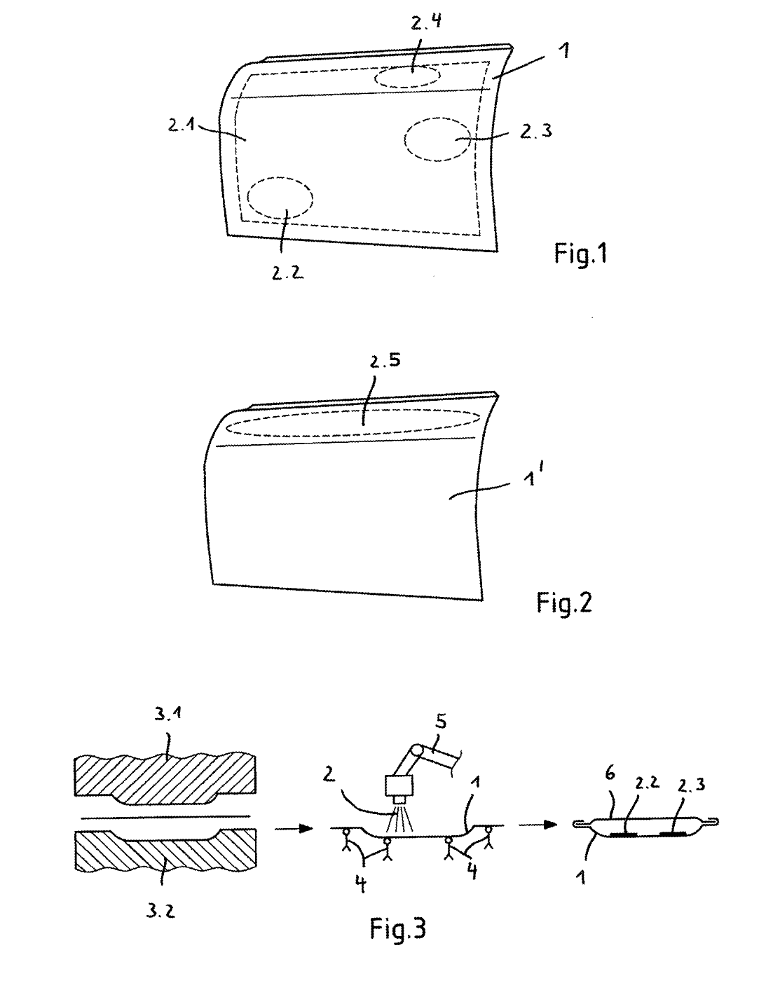

FIG. 1 shows an outer view of a three-dimensionally shaped vehicle door outside panel which is back injection molded on the inside extensively and locally with plastic;

FIG. 2 shows an outer view of a three-dimensionally shaped vehicle door outside panel which is back injection molded on the inside in the region of the door windowsill locally with plastic; and

FIG. 3 shows a sketch of a method sequence according to the invention for producing a large outer paneling part for a movably mounted body part of a motor vehicle, in particular for a vehicle door.

FIGS. 1 and 2 illustrate shaped outside panels 1, 1′ of a vehicle door. The respective panel part 1, 1′ has a sheet metal thickness of less than 0.6 mm, preferably less than 0.5 mm, for example of approx. 0.2 mm, and has been produced from a correspondingly thin metal blank, preferably a steel blank, by deep drawing. The inside of the large panel part 1, 1′ is back injection molded with plastic 2.1, 2.2, 2.3, 2.4 and/or 2.5 for its reinforcement and therefore in order to increase its buckling resistance. The plastic used for this purpose may be a pure plastic, i.e. a plastic without reinforcing fibers. Use is preferably made of plastics which are stable to cathodic dip coating, in particular thermoplastics, preferably on the basis of PA, PE or mixtures thereof. However, in order to increase the rigidity, fibers, for example glass fibers, carbon fibers, etc., may also be admixed with the plastic.

The inside plastics reinforcement of the thin panel part 1, 1′ may be, but does not absolutely have to be, formed over the full surface area. The plastics reinforcement is preferably formed locally in multiple layers at points of the thin panel part 1, 1′ that are particularly critical in terms of buckling. For example, two, three or more plastics layers can be applied in regions one above another by back injection molding the inside of the panel part 1, 1′. Said layers can be produced here from an identical plastic or from different plastics, in particular from fiber-reinforced plastic and plastic which is not fiber reinforced.

In the exemplary embodiment illustrated in FIG. 1, a relatively large plastics layer 2.1 is applied on the inside of the panel part (outside door panel) 1, and a plurality of relatively small plastics layers 2.2, 2.3, 2.4 are applied in regions thereabove by back injection molding. The small plastics layers 2.2, 2.3, 2.4 are optionally arranged at points of the thin panel part 1 that are particularly critical in terms of buckling. As mentioned above, a plurality of, for example two, three or four or more, relatively small plastics layers can also be applied one above another locally at such points.

Furthermore, by means of specific back injection molding of a large thin outside panel (for example outside door panel) with plastic, which is assembled together with further panel parts to form a movably mounted body part, the present invention makes it possible to save one or more metallic reinforcement parts of the body part. For example, in the case of the outside door panel 1′ sketched in FIG. 2, a plastics reinforcement 2.5 is applied on the inside in the region of the door windowsill. Such a local plastics reinforcement 2.5 makes it optionally possible to dispense with a metallic door windowsill reinforcement customarily provided in the door. For this purpose, the local plastics reinforcement 2.5 preferably has a multilayered construction.

FIG. 3 sketches the basic sequence of the production method according to the invention. The panel part 1 formed by deep drawing from a metal blank A, preferably steel blank, having a thickness of between 0.15 mm and below 0.6 mm, is an outer skin component for a movably mounted body part. A stamp and a die-plate of a forming die are denoted by 3.1 and 3.2, respectively. After the deep drawing, the outer skin component 1 is accommodated in a manner secured in a holder 4 corresponding to the desired outer contour of the outer skin component and is back injection molded on its inside with plastic 2 in regions at predetermined points, preferably in multiple layers. The plastic 2 is preferably applied by means of a robot 5. After the application of the plastic 2.1, 2.2, the outer skin component (for example outside door panel) is joined in a conventional manner by folding, preferably using adhesive, to an inner structure 6 which is produced from metal sheet (for example steel sheet) and/or plastic. The body part assembled in this manner is subsequently mounted on the associated body structure and guided together therewith through a cathodic dip coating bath for coating purposes.

In addition to the increase in the buckling resistance, the plastic 2.1, 2.2, 2.3, 2.4 and/or 2.5 applied onto the inside of the outer skin component 1, 1′ also has a positive effect on the acoustic properties of the body part concerned. Additional “noise suppression mats” or heavyweight mats which, in particular in the case of a vehicle door, constitute a not inconsiderable additional weight can thus be dispensed with.

The realization of the invention is not restricted to the exemplary embodiments illustrated in the drawing. On the contrary, numerous variants are conceivable which, even when a design differs from the examples shown, make use of the invention specified in the attached claims. The effect of the local reinforcement of the buckling resistance by back injection molding the inside of a thin outside door panel with plastic can thus also be used in further outer skin components, such as the engine hood and tailgate.

In the case of an engine hood, a suitable layer combination or thickness of the plastics coating applied on the inside can additionally have a positive influence on the protection of pedestrians, in particular in respect of reducing head impact injuries. In order to acquire a good evaluation for the protection of pedestrians, it is currently required for a distance of approx. 10 cm to be maintained between the engine hood and the structure located therebelow (body and engine). However, this is not always readily possible because of the specific arrangement of a number of body parts, for example the suspension strut domes and engine components. If the distance falls short of the stated distance, the impacting person frequently experiences a secondary impact, and therefore the values for the “HIC (head-injury-criterion)” at such regions of the engine hood dramatically increase. However, in said regions, a suitable plastics back injection molding of the outside panel of the hood can make the secondary impact softer, and therefore no increased HIC values are measured in this case.

1.-14. (canceled)

15. A method for producing an outer paneling part for a door, a front hood, or a tailgate of a motor vehicle, the method comprising:
using a forming die to form a metallic panel into a formed panel part having a three-dimensional shape, wherein the metallic panel has a sheet metal thickness of less than 0.6 mm;
applying a plastic reinforcement to at least a portion of an inside of the formed panel part by back injection molding; and
connecting the formed reinforced panel part to an inner structure produced from at least one of metal sheet or plastic, wherein the connecting occurs by at least one of folding or adhesive bonding.

16. The method of claim 15 wherein the plastic reinforcement is applied to the formed panel part by back injection molding as the formed panel part is secured by a holder outside the forming die.

17. The method of claim 15 wherein the plastic reinforcement is applied locally in one layer.

18. The method of claim 15 wherein the plastic reinforcement is applied locally in multiple layers.

19. The method of claim 18 wherein the multiple layers are formed from different plastics.

20. The method of claim 15 wherein the plastic reinforcement comprises a plastic with a permanent temperature stability of at least 120 degrees Celsius.

21. The method of claim 15 wherein the plastic reinforcement comprises a fiber-reinforced plastic.

22. An outer paneling part for a movable large body part of a motor vehicle, the outer paneling part comprising:
a metallic panel part having a three-dimensional shape and a sheet metal thickness of less than 0.6 mm, the metallic panel part having an inside and an outside;
a plastic reinforcement disposed to at least a portion of the inside of the metallic panel part by back injection molding; and
an inner structure connected to the metallic panel part by at least one of folding or adhesive bonding of the metallic panel part, wherein the inner structure is produced from at least one of metal sheet or plastic.

23. The outer paneling part of claim 22 wherein the plastic reinforcement comprises a single layer of plastic.

24. The outer paneling part of claim 22 wherein the plastic reinforcement comprises multiple layers of plastic.

25. The outer paneling part of claim 24 wherein the multiple layers of plastic comprise different types of plastic.

26. The outer paneling part of claim 22 wherein the plastic reinforcement has a permanent temperature stability of at least 120 degrees Celsius.

27. The outer paneling part of claim 22 wherein the plastic reinforcement comprises fiber-reinforced plastic.
